(19) United States
(12) Patent Application Publication
(10) Pub. No.: US 2020/0226647 A1
(43) Pub. Date: Jul. 16, 2020

(54) APPARATUS FOR MANAGING CUSTOMER REVIEWS AND INFORMATION PROCESSING METHOD BY THE SAME

(71) Applicant: TOSHIBA TEC KABUSHIKI KAISHA, Tokyo (JP)

(72) Inventor: Masayuki TANAKA, Yokohama Kanagawa (JP)

(21) Appl. No.: 16/654,938

(22) Filed: Oct. 16, 2019

(30) Foreign Application Priority Data
Jan. 16, 2019 (JP) 2019-005354

(51) Int. Cl. G06Q 30/02; G06Q 20/20

(52) U.S. Cl. CPC G06Q 30/0282; G06Q 20/209

(57) ABSTRACT

An apparatus for managing customer reviews includes a processor programmed to generate receipt data for display on a receipt screen showing a transaction object for which a transaction has been performed, select a transaction object in response to an instruction from the customer, acquire review data input by the customer into a contribution input screen of the selected transaction object; and output the review data as the review relating to the selected transaction object. The apparatus also includes a communication interface configured to receive a request to generate the receipt data and a memory configured to store the transaction data and the review data.

### CROSS-REFERENCE TO RELATED APPLICATION

This application is based upon and claims the benefit of priority from Japanese Patent Application No. 2019-005354, filed on Jan. 16, 2019, the entire contents of which are incorporated herein by reference.

### FIELD

Embodiments described herein relate generally to an apparatus for managing customer reviews and an information processing method by the same.

### BACKGROUND

A service for collecting reviews relating to a commodity on a social networking website is known. In such a service, reviews contributed by customers are collected.

The collected reviews are used only to the extent that a browser could read the collected reviews to know other customer comments, and there is a difficulty in making more effective use of the reviews.

### DESCRIPTION OF THE DRAWINGS

FIG. 1 is a block diagram illustrating a schematic configuration of an electronic receipt system according to an embodiment and a circuit configuration of main portions of a receipt server of the electronic receipt system;

FIG. 2 is a diagram schematically illustrating a structure of a data record included in a transaction database in FIG. 1;

FIG. 3 is a diagram schematically illustrating a structure of a data record included in a review database in FIG. 1;

FIG. 4 is a flowchart depicting an information processing for receipt browsing by a processor in FIG. 1;

FIG. 5 is a diagram illustrating a receipt screen;

FIG. 6 is a diagram illustrating a contribution screen in an initial state;

FIG. 7 is a diagram illustrating a contribution screen after a change by a customer; and

FIG. 8 is a flowchart depicting an information processing relating to output of review data by the processor in FIG. 1.

### DETAILED DESCRIPTION

In accordance with an embodiment, an apparatus for managing customer reviews comprises a processor programmed to generate receipt data for display on a receipt screen showing at least one transaction object for which a transaction has been performed based on transaction data, the transaction data being associated with a customer and including information containing identification data for identifying the transaction object the customer receives at the time of the transaction. The processor is further programmed to select a transaction object in response to an instruction from the customer, acquire review data input by the customer into a contribution input screen of the selected transaction object, and output the review data as the review data relating to the selected transaction object. The apparatus further comprises a communication interface configured to receive a request to generate the receipt data and a memory configured to store the transaction data and the review data.

Hereinafter, an embodiment is described with reference to the accompanying drawings. The present embodiment relates to an electronic receipt system in which an electronic receipt service is provided by a receipt server having a function as the customer review management apparatus.

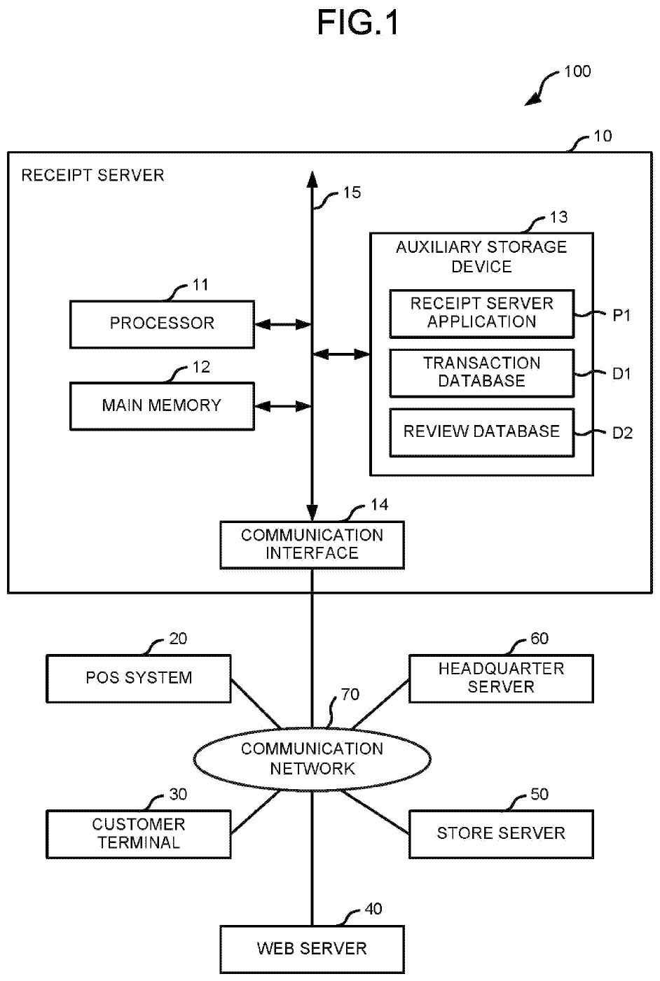

FIG. 1 is a block diagram illustrating a schematic configuration of an electronic receipt system 100 according to the present embodiment and a circuit configuration of main portions of a receipt server 10 included in the electronic receipt system 100.

The electronic receipt system 100 is configured in such a manner that the receipt server 10, a POS (point-of-sale) system 20, a customer terminal 30, a web server 40, a store server 50, and a headquarter server 60 can communicate with each other via a communication network 70. As the communication network 70, the Internet, a VPN (Virtual Private Network), an LAN (Local Area Network), a public communication network, a mobile communication network, etc. can be used alone or in combination as appropriate.

The receipt server 10 collects transaction data indicating, for each transaction, contents of a transaction registered in the POS system 20 and a settlement result of the transaction performed with the POS system 20 to manage the transaction data. Based on the transaction data, the receipt server 10 provides the browser with a receipt screen showing, for each transaction, details of the transaction and the settlement.

A transaction refers to receipt of a transaction object by a customer from a provider. In the present embodiment, the transaction is to provide, as the transaction object, a commodity relating to food and drink in a retail store of a food and drink provider. However, the transaction object is not limited to the commodity relating to food and drink. As another example, the transaction object may be a commodity to be provided to the customer without any charge. The commodity in this case includes food and drink taken away by the customer. The transaction object may be an intangible service such as a massage provided by the provider to the customer in the retail store. The transaction object may be a service in which the provider recovers an article brought in by the customer. Although in the present embodiment, the transaction is made for remuneration, it may be made for free.

The POS system 20 is installed in a retail store or the like, and performs an information processing for registering contents of a transaction made in the retail store or the like and settling the transaction. The POS system 20 may perform any other information processing for transaction management, such as sales totalization. The POS system 20 generates the above-described transaction data for each of the registered and settled transactions, and then transmits the generated transaction data to the receipt server 10. The POS system 20 may generate and transmit the transaction data if the customer is a member of an electronic receipt service. For example, an existing system may be used as the POS system 20. The POS system 20 includes a transaction code for identifying the transaction in the transaction data. The POS system 20 includes the transaction data and a store code for identifying the retail store in which the transaction is made. The store code is used for identifying a retail store serving as the provider, and is an example of provider data. The POS system 20 includes, in the transaction data, a commodity list that is a list of commodity codes serving as identification codes for identifying the commodities serving as the transaction objects. The POS system 20 includes settlement data indicating a settlement result of the transaction data. The POS system 20 includes, in the settlement data, for example, a date and time of completion of the settlement, an identification code of a POS terminal that performs the settlement, an identification code of a store clerk who handles the transaction, or a name of the store clerk. The POS system 20 includes, in the settlement data, for example, a media code for identifying a settlement media used for the settlement. The settlement media to be applied may be any media, such as a credit settlement, an electronic money settlement, a coupon settlement, a point settlement, a QR Code® settlement, a prepaid card settlement, a debit card settlement, or digital currency settlement. The POS system 20 includes, in the settlement data, predetermined data required to confirm the settlement result with each settlement media. The data includes a settlement amount, a deposit amount, a change amount, etc., if the cash settlement is applied as the settlement media. A customer who uses the electronic receipt service provided by the electronic receipt system 100 has a member code issued when the customer is registered in advance. Then, the customer inputs the member code into the POS system 20 at the time of performing a transaction in which the management of the transaction data by the receipt server 10 is required. The POS system 20 includes the member code thus input in the transaction data.

The customer terminal 30 displays a receipt screen provided by the receipt server 10 in response to an operation performed by a customer who is a member of the electronic receipt service. Generally, a plurality of customer terminals 30 is included in the electronic receipt system 100, but only one customer terminal 30 is shown in FIG. 1. The plurality of customer terminals 30 may be used by the same customer or may be used individually by different customers. Alternatively, one customer terminal 30 may be shared by a plurality of customers. The customer terminal 30 is typically a portable information processing apparatus such as a smartphone, a mobile phone or a tablet terminal. The customer terminal 30 may be a stationary information processing apparatus such as a desktop personal computer.

The web server 40 performs an information processing for providing a web service via the communication network 70. One of the web services provided by the web server 40 is a service provided by a social networking website. Specifically, the web server 40 collects reviews contributed by any contributor, and provides a service for enabling any browser to browse the reviews.

The store server 50 performs an information processing for sales management in a retail store in which the POS system 20 is installed. The store server 50 is typically installed in the retail store in which the POS system 20 is installed.

The electronic receipt system 100 manages transaction data relating to transactions made in a plurality of retail stores serving as member stores typically. In this case, the electronic receipt system 100 includes a plurality of POS systems 20 and a plurality of store servers 50. However, in FIG. 1, only one POS system 20 and one store server 50 are shown. The plurality of retail stores in which the plurality of POS systems 20 is respectively installed may all belong to a single company, or may be stores belonging to different companies.

The headquarter server 60 collectively manages a plurality of retail stores in which each POS system 20 is installed, and performs an information processing for sales management in these retail stores. The headquarter server 60 typically collectively manages a plurality of retail stores that belong to a single company. If retail stores belonging to different companies are mixed in the electronic receipt system 100, a plurality of headquarter servers 60 is included in the electronic receipt system 100. However, in FIG. 1, only one headquarter server 60 is shown.

The receipt server 10 includes a processor 11, a main memory 12, an auxiliary storage device 13, a communication interface 14 and a transmission line 15. The processor 11, the main memory 12, the auxiliary storage device 13 and the communication interface 14 are connected to each other via the transmission line 15.

The processor 11, the main memory 12 and the auxiliary storage device 13 are connected via the transmission line 15 to constitute a computer that performs an information processing for controlling the receipt server 10.

The processor 11 acts as a central component of the computer. The processor 11 controls each section to perform various functions of the receipt server 10 by executing information processing programs such as an operating system, middleware, and application programs.

The main memory 12 acts as a main storage component of the computer. The main memory 12 includes a non-volatile memory area and a volatile memory area. The main memory 12 stores the information processing programs in the non-volatile memory area. The main memory 12 stores data necessary for the processor 11 executing a processing for controlling each section in the non-volatile or volatile memory area. The main memory 12 uses the volatile memory area as a work area in which data is appropriately rewritten by the processor 11.

The auxiliary storage device 13 acts as an auxiliary storage component of the computer. The auxiliary storage device 13 is, for example, an EEPROM (electric erasable programmable read-only memory), an HDD (Hard Disc Drive), an SSD (Solid State Drive), or any combination thereof. The auxiliary storage device 13 stores data to be used at the time the processor 11 performs various processing, and data generated by the processor 11 in the processing. The auxiliary storage device 13 stores the information processing programs. One of the information processing programs stored in the auxiliary storage device 13 is an application program (hereinafter, referred to as a receipt server application) P1 for operation of the receipt server 10. The auxiliary storage device 13 stores a transaction database D1 and a review database D2. The transaction database D1 and the review database D2 are described below.

The communication interface 14 is used for establishing data communication via the communication network 70. The communication interface 14 may be, for example, a known communication device for establishing data communication via the Internet.

The receipt server 10 can use, for example, a general-purpose computer device as basic hardware. Before a receipt server application P1 is stored in the auxiliary storage device 13, the receipt server application P1 can be transferred to the auxiliary storage device 13 by being copied from a removable recording media such as a magnetic disk, a magneto-optical disk, an optical disk, a semiconductor memory or the like, or being downloaded via a network. In this case, the receipt server application P1 is written to the auxiliary storage device 13 in response to an operation by an administrator of the receipt server 10 or an operator of the receipt server 10. However, the receipt server 10 in a state in which the receipt server application P1 is stored in the auxiliary storage device 13 may be delivered to the administrator or operator.

The transmission line 15 includes an address bus, a data bus, a control signal line and the like, and transmits data and control signals transmitted and received between the connected sections.

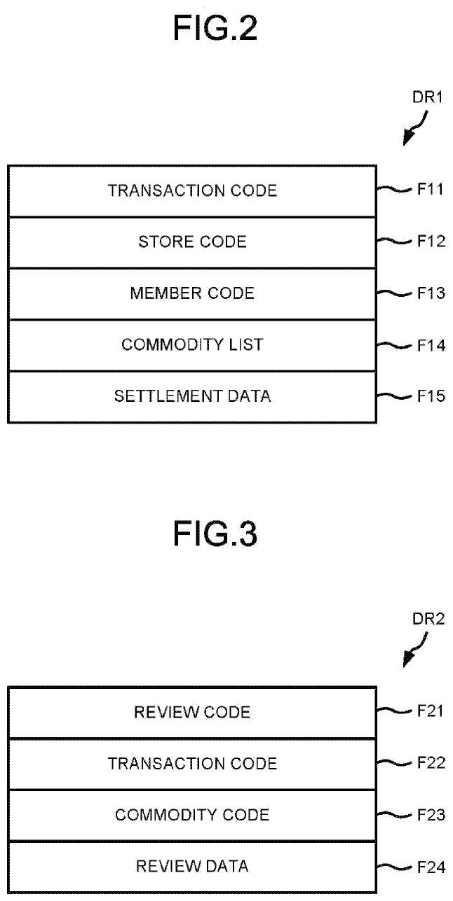

FIG. 2 is a diagram schematically illustrating a structure of a data record DR1 included in the transaction database D1.

The transaction database D1 is a set of data records DR1 respectively associated with a plurality of transactions. The data record DR1 includes fields F11, F12, F13, F14 and F15. In the field F11, a transaction code for identifying a transaction associated with the data record DR1 is set. In the field F12, a store code for identifying a retail store in which the transaction associated with the data record DR1 is performed is set. In the field F13, a member code for identifying a customer in the transaction associated with the data record DR1 is set. In the field F14, a list of commodities serving as the transaction objects in the transaction associated with the data record DR1 is set. In the field F15, settlement data indicating a settlement result of the transaction associated with the data record DR1 is set.

If the transaction data transmitted from the POS system is transmitted to the receipt server 10 through the communication network 70, the communication interface 14 receives the transaction data. In response to this, the processor 11 adds a new data record DR1 in which the transaction code, the store code, the member code, the commodity list and the settlement data are set in the fields F11 to F15, respectively, to the transaction database.

FIG. 3 is a diagram schematically illustrating a structure of a data record DR2 included in the review database D2.

The review database D2 is a set of data records DR2 respectively associated with a plurality of reviews. The data record DR2 includes fields F21, F22, F23 and F24. In the field F21, a review code for identifying a review associated with the data record DR2 is set. In the field F22, a transaction code for identifying a transaction serving as an object of evaluation by the review associated with the data record DR2 is set. In the field F23, a commodity code for identifying a commodity serving as an object of evaluation by the review associated with the data record DR2 is set. In the field F24, review data indicating contents of the review associated with the data record DR2 is set.

Next, an operation performed by the electronic receipt system 100 is described. For example, an operation performed by an existing electronic receipt system may be applied for collecting the transaction data from the POS system 20 to the receipt server 10. The characteristic points of the operation performed by the electronic receipt system 100 of the present embodiment lie in operations relating to the acquisition of review data in the receipt server 10 and the output of the review data from the receipt server 10. Therefore, in the following, the description of an operation that can apply the existing operation is omitted, and the above characteristic operations are mainly described. The contents of the processing described below are merely an example, and various modifications such as change in the order of a part of processing, omission of a part of processing, or addition of another processing may be appropriately made.

If a customer wants to confirm contents of the transaction that the customer made in the past, the customer uses the customer terminal 30 to perform a predetermined operation for requesting the start of receipt browsing. In response to this operation, the customer terminal 30 transmits request data including a predetermined command for requesting start of receipt browsing and a member code for identifying the customer to the receipt server 10 via the communication network 70. The request data is received by the communication interface 14 of the receipt server 10 and then transmitted to the processor 11. Then, the processor 11 confirms that the start of receipt browsing is requested based on the request data, and starts the following information processing for receipt browsing.

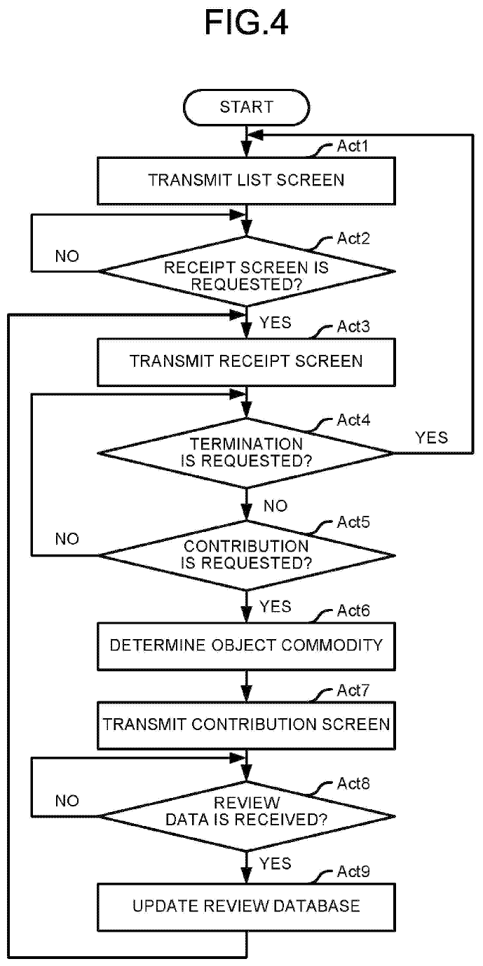

FIG. 4 is a flowchart depicting an information processing for receipt browsing by the processor 11. The processor 11 executes the information processing by executing the receipt server application P1. The processor 11 executes the information processing shown in FIG. 4 for a session set up with the customer terminal 30 that transmits the request data that triggers the information processing. If the request data transmitted from another customer terminal 30 arrives while the information processing shown in FIG. 4 is being executed, the processor 11 sets up another session with the other customer terminal 30 and then performs the information processing shown in FIG. 4 in parallel with the session of the first customer. In the following description of FIG. 4, the customer terminal 30 that is the object of the session is simply referred to as the customer terminal 30. For example, while executing the processing shown in FIG. 4, the processor 11 manages the member code included in the request data in association with a session ID (identifier) for identifying the session set up in relation to the processing. The session may be established prior to the request for receipt browsing. In this case, the transmission of the member code from the customer terminal 30 to the receipt server 10 is performed at the time the session is established.

The processor 11 transmits a list screen to the customer terminal 30 in Act 1. The list screen shows a list of transactions of the customer who uses the customer terminal 30. Specifically, the processor 11 extracts all data records DR1 in which the member code included in the request data is set in the field F13 from the transaction database D1. The processor 11 generates the list screen showing a list of transactions associated with each of the extracted data records DR1. A settlement date and time included in the settlement data and a name of a retail store identified by the store code are also shown in the list screen as the information indicating individual transactions such that the customer can easily identify each of the transactions. Then, the processor 11 transmits screen data for displaying the list screen generated in this manner on the customer terminal 30 to the customer terminal 30. The screen data may be data in a JPEG (Joint Photographic Coding Experts Group) format which directly indicates an actual screen, or data in an HTML (Hypertext Markup Language) format which is used for configuring a screen in the customer terminal 30. The processor 11 includes, in the screen data, control data for controlling the customer terminal 30 to transmit the request data in response to an operation of designating a transaction shown in the list screen. The request data includes a transaction code for identifying a designated transaction, and a predetermined command for requesting display of the receipt screen.

If the customer terminal 30 receives the screen data transmitted from the receipt server 10 as described above, the customer terminal 30 displays the list screen based on the received screen data. The customer selects a transaction for which the receipt screen is to be displayed from the list screen, and performs an operation for designating the transaction on the customer terminal 30. In response to this operation, the customer terminal 30 transmits the request data to the receipt server 10 via the communication network according to the control data. The request data is received by the communication interface 14 of the receipt server 10 and then transmitted to the processor 11.

In Act 2, the processor 11 stands by until the receipt screen is requested from the customer terminal 30. Then, if the request data for requesting the receipt screen is received by the communication interface 14, the processor 11 determines Yes, and then proceeds to the processing in Act 3.

The processor 11 transmits the receipt screen in Act 3. For example, the processor 11 extracts, from the transaction database D1, the data record DR1 associated with a transaction identified by the transaction code included in the request data (hereinafter referred to as a designated transaction). The processor 11 then generates the receipt screen as a screen showing the details of the designated transaction based on the extracted data record DR1. The processor 11 transmits screen data (hereinafter referred to as receipt data) for enabling the customer terminal 30 to display the receipt screen generated in this manner to the customer terminal 30.

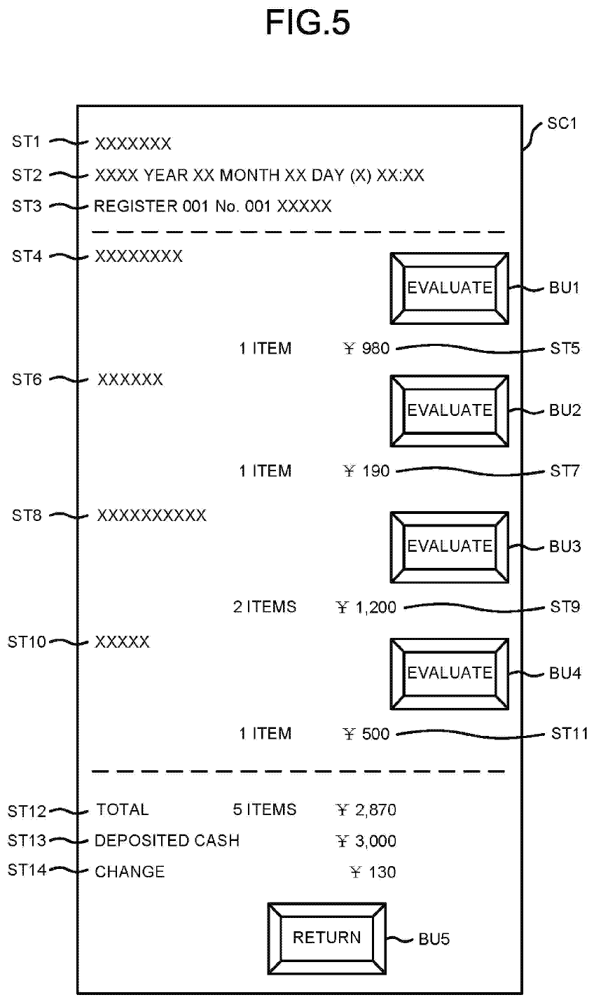

FIG. 5 is a diagram illustrating a receipt screen SC1. The receipt screen SC1 is merely an example, and if the designated transaction changes, contents of the receipt screen also change. The receipt screen SC1 is shown by replacing some characters with “x”.

The receipt screen SC1 includes character strings ST1 to ST14 and buttons BU1 to BU5.

The character string ST1 indicates the store name of the retail store in which the designated transaction is made. The character string ST2 indicates the settlement date and time. The character string ST3 indicates the identification code identifying the POS terminal that performs the settlement, the identification code identifying a store clerk who handles the transaction and the name of the store clerk.

The character string ST4 indicates a name of one commodity that is the object of the designated transaction. The character string ST5 indicates the quantity and price of the commodity having the name indicated by the character string ST4. The button BU1 is a GUI (Graphical User Interface) element to be operated by the customer when the customer desires to contribute a review of the commodity having the name indicated by the character string ST4. Thus, the character strings ST4 and ST5 and the button BU1 are associated with one common commodity. The character strings ST6 and ST7 and the button BU2, the character strings ST8 and ST9 and the button BU3, the character strings ST10 and ST11 and the button BU4 are respectively paired to be associated with individual commodities, and have the same functions as the character strings ST4 and ST5 and the button BU1, respectively.

The receipt screen SC1 is an example of the receipt screen showing a transaction for five commodities in four types in total. Therefore, there are four sets of combinations of the character strings ST4, ST6, ST8 and ST10 indicating the names of the commodities, the character strings ST5, ST7, ST9 and ST11 indicating the quantity and price of the corresponding commodity, and the buttons BU1, BU2, BU3 and BU4. However, since the number of types of commodities serving as transaction objects varies for each transaction, the number of combinations to be included of the character strings indicating the names, the character strings indicating the quantity and price, and the buttons changes for each receipt screen.

The character string ST12 indicates a total quantity of all the commodities to be settled and a settlement amount as the total prices of the commodities. The character string ST13 indicates an amount of cash deposited by the customer for cash settlement. The character string ST14 indicates an amount of change paid back to the customer. These character strings ST12 to ST14 are examples in which the settlement media is cash. If the settlement media is changed, the processor 11 replaces the character strings ST12 to ST14 with other character strings corresponding to the settlement media.

The button BU5 is a GUI element to be operated by the customer if the customer wants to return the screen display to the list screen.

Thus, the processor 11 executes the information processing program, and in this way, the computer having the processor 11 as the central component functions as a generation module for generating the receipt screen.

The processor 11 includes, in the receipt data indicating the receipt screen SC1, control data for controlling the customer terminal 30 to transmit notification data if any one of the buttons BU1 to BU5 is operated. The notification data includes a button code for identifying the operated button and a predetermined command relating to notification of the operated button. Therefore, the processor 11 assigns a button code to each of the buttons to be included in the receipt screen at the time of generating the receipt screen. The button paired with the commodity name, such as the buttons BU1 to BU4 on the receipt screen SC1, is associated with the commodity code for identifying the commodity having the paired commodity name.

If the customer terminal 30 receives the receipt data transmitted from the receipt server 10 as described above, the customer terminal 30 displays the receipt screen based on the receipt data. The customer can confirm the details of the designated transaction by viewing the receipt screen. If the customer wants to contribute a review about any one of the commodities shown on the receipt screen, the customer operates a button associated with the commodity for which the customer wants to contribute the review on the customer terminal 30 among the buttons BU1 to BU4. In response to this operation, the customer terminal 30 transmits the notification data including the button code for identifying the operated button to the receipt server 10 via the communication network 70 according to the control data. The notification data is received by the communication interface 14 of the receipt server 10 and then transmitted to the processor 11.

In Act 4, the processor 11 determines whether or not the termination of the display of the receipt screen is requested. Then, if the termination of the display is not requested, the processor 11 determines No, and then proceeds to the processing in Act 5.

In Act 5, the processor 11 determines whether or not the contribution of a review is requested. If the contribution of a review is not requested, the processor 11 determines No, and then returns to the processing in Act 4.

Thus, in Act 4 and Act 5, the processor 11 stands by until the termination of the display of the receipt screen or the contribution of a review is requested. If the notification data is transmitted by the communication interface 14 as described above, the processor 11 determines Yes in Act 5, and proceeds to the processing in Act 6.

In Act 6, the processor 11 determines a commodity serving as an object of the contribution of the review (hereinafter, referred to as an object commodity). For example, the processor 11 determines, as the object commodity, a commodity identified by the commodity code associated with the button code included in the notification data when the receipt screen is generated. Here, the processor 11 selects one of the commodities as the transaction objects in response to the instruction from the customer based on the receipt screen. Specifically, the processor 11 executes the information processing program, and in this way, the computer having the processor 11 as the central component functions as a selection module for selecting the commodity as described above.

The processor 11 transmits a contribution screen in Act 7. The contribution screen is used for receiving input of the review to be contributed by the customer. For example, the processor 11 generates the contribution screen by adding character strings through which the customer can recognize the designated transaction and the object commodity to a predetermined basic form of the contribution screen. Then, the processor 11 transmits screen data for enabling the customer terminal 30 to display the contribution screen generated in this manner to the customer terminal 30.

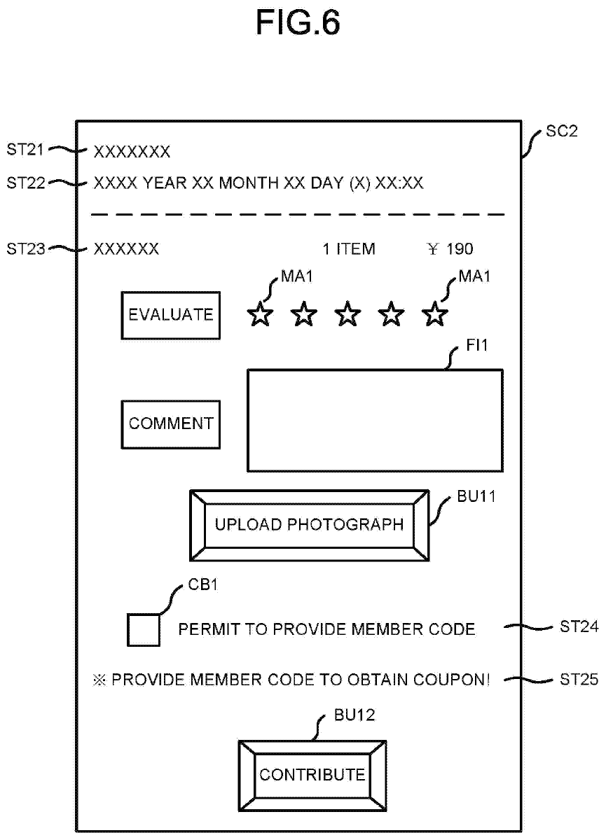

FIG. 6 is a diagram illustrating a contribution screen SC2. The contribution screen SC2 is an example in which the button BU2 on the receipt screen SC1 is operated, and contents of the contribution screen also change if a transaction set as the designated transaction and a commodity set as the object commodity change. The contribution screen SC2 is shown by replacing some characters with “x”.

The contribution screen SC2 includes character strings ST21 to ST25, a mark MA1, an input field FI1, buttons BU11 and BU12 and a check box CB1.

The character string ST21 indicates a store name of the retail store in which the designated transaction is made. The character string ST22 indicates a settlement date and time of the designated transaction. The character string ST23 indicates a commodity name, a quantity, and a price of the object commodity. Specifically, the processor 11 sets the character strings ST1 and ST2 on the receipt screen SC1 as the character strings ST21 and ST22. The processor 11 combines the character string ST4 and the character string ST5 on the receipt screen SC1 to form the character string ST23.

As shown in FIG. 6, five marks MA1 are shown side by side, and the marks MA1 are GUI elements for evaluating the object commodity on a scale of 1 to 5. A display state of the mark MA1 shown in FIG. 6 indicates an unevaluated state. The input field FI1 is used for inputting a comment. The button BU11 is a GUI element to be operated by the customer to declare selection of the image data to be contributed. The marks MA1, the input field FI1 and the button BU11 described above are user interfaces through which the customer sets contents of the review to be contributed.

The button BU12 is a GUI element to be operated by the customer to confirm that the contents shown in the contribution screen SC2 are to be submitted. The check box CB1 is a GUI element through which the customer permits the receipt server 10 to provide the member code together with the review data to the social networking website.

The character string ST24 explains the use of the check box CB1 to the customer. The character string ST25 shows benefits to be given to the customer if the member code is permitted to be provided.

On the contribution screen SC2, for example, the character strings ST21, ST22 and ST23 are added by the processor 11 to make the designated transaction and the object commodity recognizable to the customer, and all the other display elements are defined as the basic form. A plurality of basic forms may be prepared in advance. Then, the processor 11 may select a basic form to be used for the contribution screen according to a predetermined rule. The rule in this case is not limited, and for example, may be defined by a creator of the receipt server application. As an example, a basic form associated with the retail store in which the designated transaction is made is used.

The processor 11 also includes the following control data in the screen data of the contribution screen SC2. One of the control data is used to control the customer terminal 30 to set an evaluation rank according to the mark selected by the customer among the five marks MA1 and change a display color of the marks MA1 according to the set evaluation rank. One of the control data is used to control the customer terminal 30 to receive the character string to the input field FI1 and set the character string as the comment. One of the control data is used to control the customer terminal 30 to call up a function for file selection in response to an operation on the button BU11 and set an image file designated by the customer through this function as the image data included in the review data. One of the control data is used to control the customer terminal 30 to transmit the review data including the set evaluation rank, the comment, and the image data to the receipt server 10 in response to an operation on the button BU12. One of the control data is used to control the customer terminal 30 to perform invert a flag indicating permission or prohibition for providing the member code in response to an operation on the check box CB1, and correspondingly switch display or non-display of the check mark to show the state of the flag.

If the customer terminal 30 receives the screen data of the contribution screen, the customer terminal 30 displays the contribution screen indicated by the screen data. In response to an operation performed by the customer on the contribution screen, a processing according to the various kinds of control data as described above is executed.

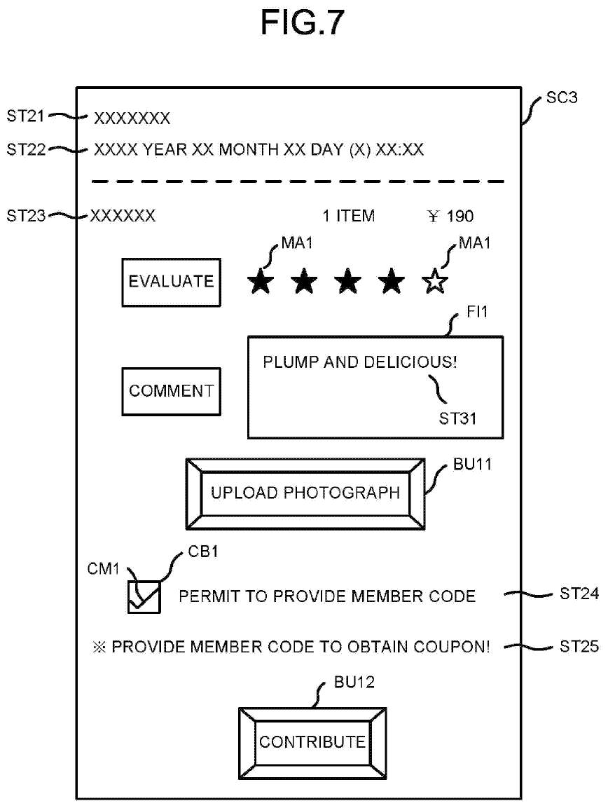

FIG. 7 is a diagram illustrating a contribution screen SC3 after the change by the customer terminal 30 in response to an operation performed by the customer. In FIG. 7, the same elements as those shown in the contribution screen SC2 shown in FIG. 6 are denoted with the same reference numerals, and detailed description thereof is omitted.

The contribution screen SC3 is an example of setting “4” in the evaluation rank and “plump and delicious!” in the comment in the contribution screen SC2. The contribution screen SC3 is an example in which the customer permits the provision of the member code. In the contribution screen SC3, the fact that the evaluation rank is set to “4” is shown by making the display color of the four marks MA1 on the left side different from that of one mark MA1 on the right side. The two display colors of the marks MA1 are not limited. The contribution screen SC3 shows a character string ST31 “plump and delicious!” in the input field FI1. The contribution screen SC3 shows a check mark CM1 superimposed on the check box CB1 to indicate that the customer permits provision of the member code.

If the button BU12 in FIG. 7 is operated by the customer, the customer terminal 30 transmits the review data indicating that the evaluation rank is “4” and the comment is “plump and delicious!” and including a flag indicating “permission” to the receipt server 10 via the communication network 70. If the image data is set, the customer terminal 30 includes the image data in the review data. The review data is received by the communication interface 14 of the receipt server 10 and then transmitted to the processor 11. Then, the processor 11 acquires the transmitted review data and executes the information processing program, and in this way, the computer having the processor 11 as the central component functions as an acquisition module for acquiring the review data.

The processor 11 stands by until the review data is received in Act 8. Then, the processor 11 proceeds to the processing in Act 9 if Yes is taken because the review data is transmitted by the communication interface 14.

The processor 11 updates the review database D2 in Act 9. For example, the processor 11 generates a new data record DR2 and updates the review database D2 to include the generated data record DR2. The processor 11 sets data in each field of the new data record DR2 as follows, for example. The processor 11 sets, in the field F21, a review code that is not set in the field F21 of any data record DR2 already included in the review database D2. The processor 11 sets the transaction code for identifying the designated transaction in the field F22. The processor 11 sets the commodity code for identifying the object commodity to the field F23. The processor 11 sets the received review data in the field F24.

Then, after the review database D2 is updated, the processor 11 returns to the processing in Act 3. Specifically, the processor 11 enables the customer terminal 30 to redisplay the receipt screen relating to the designated transaction, and repeats the processing subsequent to Act 4 in the same manner as described above to respond to the operation performed by the customer on the receipt screen.

When the customer wants to terminate the display of the current receipt screen, for example, when the customer wants to confirm contents of a transaction different from the transaction corresponding to the receipt screen displayed on the customer terminal 30, the customer performs a predetermined operation such as operating the button BU5 to declare that intention. Then, if such an operation is notified from the customer terminal 30 to the receipt server 10, the processor 11 determines Yes in Act 4, and returns to the processing in Act 1. Specifically, the processor 11 enables the customer terminal 30 to redisplay the list screen, and repeats the processing subsequent to Act 2 to respond to the operation performed by the customer on the list screen.

As described above, the receipt server 10 collects the review data contributed by the customer and accumulates the contributed review data in the review database D2. Then, in response to a request from the web server 40, the store server 50, or the headquarter server 60, the receipt server 10 outputs the review data accumulated in the review database D2. The information processing relating to the output of the review data performed by the processor 11 is described below.

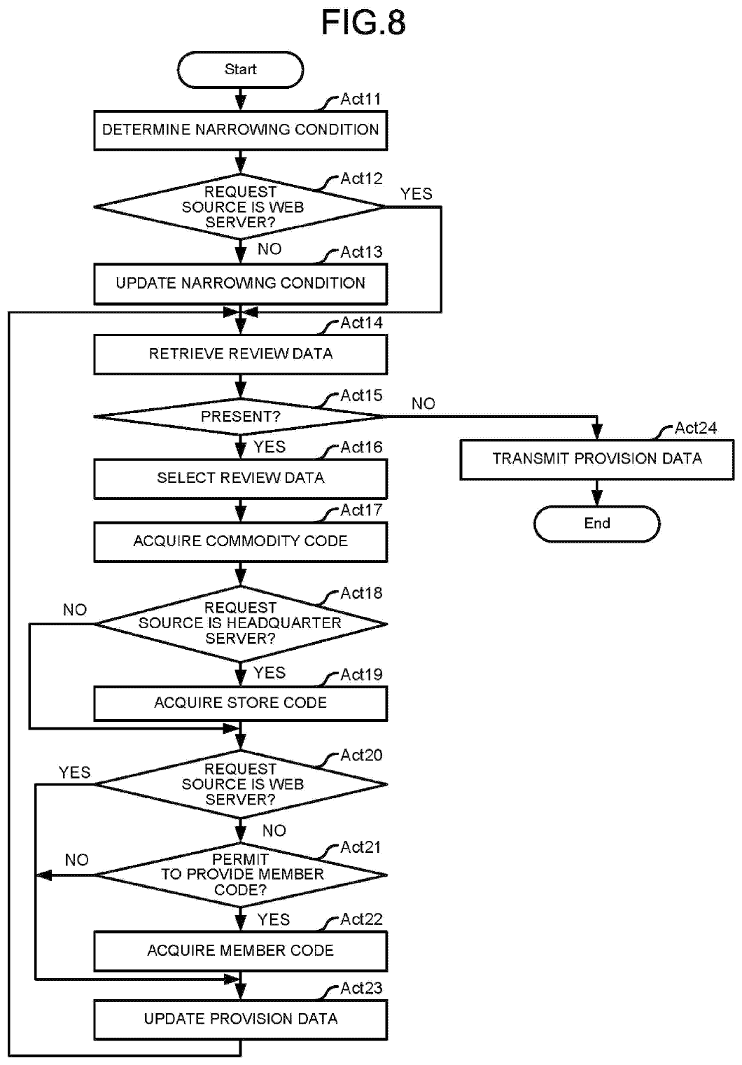

FIG. 8 is a flowchart depicting an information processing relating to the output of the review data by the processor 11.

In Act 11, the processor 11 determines a narrowing condition for narrowing down the review data to be provided among the review data accumulated in the review database D2. Any narrowing condition may be set at a request source, for example. Then, for example, data indicating the narrowing condition is included in the request data for requesting provision of the review data and transmitted from the web server 40, the store server 50, or the headquarter server 60. The processor 11 determines the narrowing condition based on this data. For example, the narrowing condition may be determined by the processor 11 according to a predetermined rule, or may be constant.

The processor 11 determines whether or not the request source is the web server 40 in Act 12. If the request source is the store server 50 or the headquarter server 60, the processor 11 determines No, and then proceeds to the processing in Act 13.

The processor 11 updates the narrowing condition in Act 13. For example, the processor 11 adds a narrowing condition for restricting the review data to be provided to the review data relating to the transaction in the retail store managed by the store server 50 or the headquarter server 60 serving as the request source to the narrowing condition determined in Act 11. The processor 11 then proceeds to the processing in Act 14. If it is determined that the request source is the web server 40 (Yes in Act 12), the processor skips the processing in Act 13 and proceeds to the processing in Act 14. Specifically, if the request source is the web server 40, the restriction according to the retail store in which the transaction is made is not a narrowing condition.

In Act 14, the processor 11 retrieves the review database D2 for the review data to be provided. For example, the processor 11 retrieves the review database D2 for the review data satisfying the narrowing condition.

In Act 15, the processor 11 determines whether or not there is corresponding review data. Then, if at least one corresponding review data is found, the processor 11 determines Yes, and then proceeds to the processing in Act 16.

The processor 11 selects one of the review data found in Act 14 in Act 16.

In Act 17, the processor 11 acquires the commodity code for identifying the commodity serving as an object of review indicated by the review data selected in Act 16. Specifically, the processor 11 acquires, for example, a commodity code set in the field F23 of the data record DR2 in which the review data selected in Act 16 is set in the field F24.

In Act 18, the processor 11 determines whether or not the request source is the headquarter server 60. If the request source is the headquarter server 60, the processor 11 determines Yes, and then proceeds to the processing in Act 19.

In Act 19, the processor 11 acquires the store code for identifying the retail store in which the commodity serving as an object of the review data selected in Act 16 is sold. Specifically, for example, the processor 11 determines the transaction code set in the field F22 of the data record DR2 in which the review data selected in Act 16 is set in the field F24. The processor 11 further selects the data record DR1 in which the transaction code determined here is set in the field F11 from the transaction database D1 to acquire the store code set in the field F12 of the data record DR1. The processor 11 then proceeds to the processing in Act 20. If the request source is not the headquarter server 60, the processor 11 determines No in Act 18, skips the processing in Act 19 and proceeds to the processing in Act 20.

In Act 20, the processor 11 determines whether or not the request source is the web server 40. Then, if the request source is the store server 50 or the headquarter server 60, the processor 11 determines No, and then proceeds to the processing in Act 21.

In Act 21, the processor 11 determines whether or not the provision of the member code is permitted for the review data selected in Act 16. The processor 11 checks, for example, a state of the flag, which is included in the corresponding review data and indicates permission or prohibition for the provision of the member code. Then, if the state of the flag indicates permission, the processor 11 determines Yes, and then proceeds to the processing in Act 22.

In Act 22, the processor 11 acquires the member code for identifying the contributor of the review data selected in Act 16. The processor 11 acquires the member code set in the field F13 of the data record DR1 selected in Act 19. Then, the processor 11 proceeds to the processing in Act 23. If the request source is the web server 40, the processor 11 determines Yes in Act 20, skips the processing in Act 21 and Act 22 and then proceeds to the processing in Act 23. If the state of the flag, which is included in the review data selected in Act 16, indicates prohibition of provision of the member code, the processor 11 determines No in Act 21, skips the processing in Act 22 and then proceeds to the processing in Act 23.

The processor 11 updates provision data in Act 23. The processor 11 adds, to the provision data, data in which at least the commodity code acquired in Act 17 is associated with the review data selected in Act 16. If the processor 11 acquires the store code in Act 19, the processor 11 includes the store code in the data to be added to the provision data as described above. Here, the store code to be added to the provision data is an example of additional data. If the member code is acquired in Act 22, the processor 11 includes the member code in the data to be added to the provision data as described above. The member code to be added to the provision data here is an example of the additional data. In a case in which the processing in Act 23 is executed first after the information processing shown in FIG. 8 is started, the processor 11 newly generates provision data including one piece of data described above to be added to the provision data.

Then, the processor 11 returns to the processing in Act 14, and repeats the processing subsequent thereto in the same manner as described above. However, in Act 14, the processor 11 excludes the review data already selected in Act 16 from the retrieval objects. In this way, the processor 11 updates the provision data to the data including all of the review data satisfying the narrowing condition. After the processing in Act 16 to Act 23 for all the review data satisfying the narrowing condition is finished, the processor 11 cannot find any review data in Act 14. Therefore, in this case, the processor 11 determines No in Act 15, and then proceeds to the processing in Act 24.

The processor 11 transmits the provision data to the request source from the communication interface 14 via the communication network 70 in Act 24. Then, when the transmission is completed, the processor 11 terminates the information processing shown in FIG. 8. The transmission of the provision data is an example of the output of provision data. Thus, the processor 11 executes the information processing program, and in this way, the computer having the processor 11 as the central component controls the communication interface 14 as an output device to function as a control module for performing the function of an output module that performs the above-described output.

As described above, according to the receipt server 10, when the review data is provided to the web server 40, the store server 50, or the headquarter server 60, the provision data includes the commodity code for identifying the object commodity of the review data in addition to the review data. Thus, the web server 40, the store server 50, or the headquarter server 60 receiving the provision data can accurately manage which commodity the contributed review indicated by the review data relates to. As a result, the review data can be more effectively utilized in the web server 40, the store server 50, or the headquarter server 60. For example, the web server 40 can collect reviews relating to the commodity designated by a browser to enable the reviews to be browsed. As another example, the web server 40 can aggregate evaluations from a plurality of contributors for each commodity to obtain evaluation with higher reliability, and can enable the reviews to be browsed. In this way, the web server 40 can provide a social networking website that can present the reviews about the commodity from other persons in such a manner that the reviews can be easily understood for the browser. For example, the store server 50 and the headquarter server 60 can collect reviews about the commodity designated by a person in charge in the retail store or headquarters to enable the person in charge to confirm the reviews. In this way, the person in charge can easily confirm the detailed evaluation by the customer for each commodity.

According to the receipt server 10, the provision data including the store code is further output to the headquarter servers 60. For this reason, the headquarter server 60 receiving the provision data can separately manage reviews about a certain commodity for each retail store in which the transaction relating to the subject commodity is made. As a result, the review data can be utilized more effectively in the headquarter server 60. For example, the person in charge of the headquarters can check the difference in evaluation by the customer for the same commodity for each retail store. Then, for example, the person in charge can find out a disreputable retail store compared to other retail stores, and promptly take some measures for improvement. The headquarter server 60 may perform an information processing to find out a disreputable retail store or to determine a recommended measure for the improvement thereof.

According to the receipt server 10, the provision data including the member code can be further output to the store server 50 and the headquarter server 60. For this reason, in the store server 50 or the headquarter server 60 receiving the provision data, a customer who contributes the review indicated by the review data included in the provision data together with the member code can be confirmed. In this way, the person in charge can confirm the preference of each customer, and can offer a promotion for each customer. The store server 50 or the headquarter server 60 may perform the information processing to analyze the preference for each customer or to determine the recommended promotion. The receipt server 10 includes the member code only in the provision data including the review data for which the provision of the member code is permitted by the contributor. Therefore, the member code is not notified in regard to the review data from the contributor who does not want to be specified as a contributor in a providing destination of the review data, and personal data is not output despite the intention of the contributor. In the present embodiment, the social networking website provided by the web server 40 is different from the electronic receipt service provided by the receipt server 10. Therefore, the receipt server 10 further does not include the member code in the provision data to be output to the web server 40 even if the contributor permits the provision of the member code. In this way, the member code for the electronic receipt service is not provided to the social networking website, and the review via the electronic receipt service to the social networking website is anonymously contributed, which reduces concerns of the contributor and contributes to active contribution.

According to the receipt server 10, if the output destination is the store server 50 or the headquarter server 60, the output object is limited to the review data relating to a transaction in the retail store managed by the store server 50 or the headquarter server 60. For this reason, the review data relating to the commodity sold in a certain retail store included in the electronic receipt system 100 is not output to other retail stores. In this way, if retail stores belonging to different companies are mixed in the electronic receipt system 100, the review data relating to a transaction made in a certain retail store is not output to the store server 50 in a company different from the retail store or a retail store belonging to the headquarter server 60 managing the retail store.

As described above, the receipt server 10 makes the data to be included together with the review data in the provision data to be output to each of the plurality of output destinations different from each other to be capable of providing flexible data such that the receipt data can be effectively utilized in each of the output destinations.

Furthermore, according to the receipt server 10, since the data to be included in the provision data together with the review data is the data relating to the commodity selected according to an instruction from the customer based on the receipt screen, the operation for designating the commodity serving as the object of the review by the customer is simple. In the provision data, the review data is associated with a commodity code for identifying the commodity shown on the receipt screen, i.e., the commodity actually purchased by the customer who browses the receipt screen. Thus, the credibility of the review can be ensured since the customer cannot contribute a review about a commodity that is not actually purchased by the customer.

The embodiment can be modified as follows.

The data indicating the commodity serving as the transaction object on the receipt screen may be another data such as, for example, an image indicating an appearance of the commodity, or may not include a part of data such as the quantity, for example.

The output destination of the provision data may be any one or two of the web server 40, the store server 50, and the headquarter server 60. The output destination of the provision data may include any other information processing apparatus in addition to the web server 40, the store server 50, and the headquarter server 60, or instead of any one of the web server 40, the store server 50, and the headquarter server 60. For example, a web server for providing a web service different from the social networking website, such as a price comparison site may be the output destination different from the web server 40, the store server 50, and the headquarter server 60.

The provision data to be output to the web server 40 may include any data other than the review data and the commodity code. For example, the provision data may include data indicating attributes of the commodity such as a transaction date and time, a store name, a price, etc., or data indicating attributes of the contributor such as a member code, an age, a nickname, etc. However, if the provision data includes the data that may identify the contributor, such as the member code, it is preferable to obtain the permission of the contributor, similar to the case of the provision data to be output to the store server or the headquarter server 60. The permission or prohibition designated at the time of member registration may be managed in association with the member code, and the permission of the contributor of including the data that may identify the contributor in the provision data in addition to a case of the above-described embodiment may be commonly applied to a plurality of provision data.

The provision data to be output to the store server 50 or the headquarter server 60 may include only the review data and the commodity code. Alternatively, the provision data to be output to the store server 50 or the headquarter server 60 may include any data other than the data shown in the above-described embodiment as described above.

Any data may be included in the review data. For example, any character string input separately from the review and relating to a request for the retail store may be included in the review data. It may be set that the review data cannot include the image data and the like.

The review data and the identification data for identifying the commodity may be output by a different method instead of the transmission to the communication network. For example, a display device may display a screen including an image showing a comment indicated by the review data and a commodity name corresponding to the commodity code as the identification data, or the above-described image may be printed by a printer. For example, a writing device may write the provision data or image data indicating the above-described image to any removable storage medium. In these cases, a computer having the processor 11 as the central component functions as a control module that controls the display device, the printer or the writing device serving as an output device to realize the function of the output module.

By cooperation with another device for providing the electronic receipt service such as an existing receipt server, a function of the apparatus for managing the review data without managing data relating to the transaction can be performed.

A part or all of the functions performed by the processor 11 executing the information processing can be realized by hardware that executes an information processing that is not according to a program, such as a logic circuit or the like. Each of the functions described above can be realized by combining hardware such as the logic circuit described above with software control.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An apparatus for managing customer reviews, the apparatus comprising:
a processor programmed to
generate receipt data for display on a receipt screen showing at least one transaction object for which a transaction has been performed based on transaction data, the transaction data being associated with a customer and including information containing identification data for identifying the transaction object the customer receives at the time of the transaction;
select a transaction object in response to an instruction from the customer;
acquire review data indicating a review contributed by the customer into a contribution input screen of the selected transaction object; and
output the review data as the review data relating to the selected transaction object;
a communication interface configured to receive a request to generate the receipt data; and
a memory configured to store the transaction data and the review data.

2. The apparatus according to claim 1, wherein
the processor is further programmed to output the review data through the communication interface to a web server providing a website that collects and publishes reviews contributed by a plurality of customers.

3. The apparatus according to claim 1, wherein
the transaction data includes provider data for specifying a provider of the transaction object, and
the processor is further programmed to output the review data through the communication interface to a prescribed output destination associated with the provider specified by the provider data.

4. The apparatus according to claim 1, wherein
the transaction data includes personal data capable of specifying the customer, and
the processor is further programmed to include the personal data in the review data only when the customer permits to include the personal data in the review data.

5. The apparatus according to claim 1, wherein
the review data is output as part of provision data which includes the review data, the identification data, and additional data, and the processor is further programmed to determine whether to include the additional data in the provision data or to make the additional data different according to an output destination to which the provision data is output among a plurality of output destinations.

6. The apparatus according to claim 5, wherein the additional data includes a store code identifying a store at which the transaction occurred or commodity code identifying the transaction object or a member code that identifies the customer.

7. The apparatus according to claim 6, wherein the processor is further programmed to provide the provision data and the additional data depending on the output destination.

8. The apparatus according to claim 7, wherein the additional data does not include a member code that identifies the customer if the output destination is a social networking web server.

9. The apparatus according to claim 7, wherein the additional data includes a store code if the output destination is a server of the store at which the transaction occurred.

10. The apparatus according to claim 7, wherein the additional data includes the commodity code if the output destination is a server that collectively manages a plurality of stores at which transactions occur.

11. An information processing method by a review management apparatus, comprising:
generating receipt data for display on a receipt screen showing at least one transaction object for which a transaction has been performed based on transaction data, the transaction data being associated with a customer and including a plurality of information at least containing identification data for identifying the transaction object the customer receives at the time of transaction;
selecting one transaction object in response to an instruction from the customer;
acquiring review data input by the customer into a contribution input screen of the selected transaction object; and
controlling an output device to output the review data as review data relating to the selected transaction object.

12. The method according to claim 11, further comprising
outputting the review data to a web server providing a website that collects and publishes reviews contributed by a plurality of customers.

13. The method according to claim 11, wherein
the transaction data includes provider data for specifying a provider of the transaction object, and the method further comprises outputting the review data to a prescribed output destination associated with the provider specified by the provider data.

14. The method according to claim 11, wherein the transaction data includes personal data capable of specifying the customer, and the personal data is included in the review data only when the customer permits to include the personal data in the review.

15. The method according to claim 11, wherein the review data is output as part of provision data which includes the review data, the identification data, and additional data, and the method further comprises determining whether to include the additional data in the provision data or to make the additional data different according to an output destination to which the provision data is output among a plurality of output destinations.

16. The method according to claim 15, wherein the additional data includes a store code identifying a store at which the transaction occurred or commodity code identifying the transaction object or a member code that identifies the customer.

17. The method according to claim 16, further comprising providing the provision data and the additional data depending on the output destination.

18. The method according to claim 17, wherein the additional data does not include the member code if the output destination is a social networking web server.

19. The method according to claim 17, further comprising providing the store code only to a server of the store at which the transaction occurred.

20. The method according to claim 17, further comprising providing the commodity code to a server that collectively manages a plurality of stores at which transactions occur.
